(19) United States
(12) Patent Application Publication
(10) Pub. No.: US 2022/0343027 A1
(43) Pub. Date: Oct. 27, 2022

(54) COMPUTATION SYSTEM AND COMPUTATION METHOD

(71) Applicants: NEC Corporation, Tokyo (JP); BAR-ILAN UNIVERSITY, Ramat Gan (IL)

(72) Inventors: Toshinori ARAKI, Tokyo (JP); Kazuma OHARA, Tokyo (JP); Hikaru TSUCHIDA, Tokyo (JP); Jun FURUKAWA, Tokyo (JP); Binyamin PINKAS, Tel Aviv (IL)

(73) Assignees: NEC Corporation, Tokyo (JP); BAR-ILAN UNIVERSITY, Ramat Gan (IL)

(21) Appl. No.: 17/762,581

(22) PCT Filed: Sep. 26, 2019
(86) PCT No.: PCT/JP2019/037742

§ 371 Date: Mar. 22, 2022

(51) Int. Cl. G06F 21/64

(52) U.S. Cl. CPC G06F 21/64

(57) ABSTRACT

A computation system according to the present disclosure includes: shuffling secure computation means for executing secure computation processing by shuffling; random bit sharing means for generating, as security parameters, K pieces of random data; and unauthorized action detecting secure computation means for determining that an exclusive OR operation of values for all rows obtained by multiplying the exclusive OR operation of each row of the tables before the shuffling processing for each data designated by the i-th random data by the i-th random bit of each row is the same as an exclusive OR operation of values for all rows obtained by multiplying the exclusive OR operation of each row of the tables after the shuffling processing for each data designated by the i-th random data by the i-th random bit of each row.

### TECHNICAL FIELD

The present disclosure relates to a computation system and a computation method.

### BACKGROUND ART

A secure computation method is a technique of carrying out computation while keeping the computation process and the computation results of individual data private from the other relevant parties. By storing data over multiple servers that are managed by third parties such as the cloud system, it is possible to execute any operation on the data. When the secure computation method is executed, no third party is able to know the individual data, the computation process, and the computation results. Therefore, the secure computation method is used for outsourcing the analytical processing of sensitive information such as personal information.

A secure computation method described in Non-Patent Literature 1 is a method of executing secure computation on distributed confidential information using the 2-out-of-3 replicated secret sharing scheme.

The 2-out-of-3 replicated secret sharing scheme generates three pieces of distributed information from the confidential information. The 2-out-of-3 replicated secret sharing scheme is a method in which, out of the three pieces of distributed information, confidential information can be recovered from any two of the three pieces of distributed information while no confidential information can be recovered at all from the remaining one thereof.

Specifically, when confidential information s of n-bits is to be distributed, s_1, s_2, and s_3 that satisfy s=(s_1+s_2+s_3) mod 2^{m} are generated, whereby distributed information (s_1, s_2), (s_2, s_3), and (s_3, s_1) are generated. 2^{m} represents m-th power of 2. Non-Patent Literature 1 describes a method of executing computation of these pieces of distributed confidential information without recovering any confidential information at all. In Non-Patent Literature 1, calculations of addition, subtraction, and multiplication are all available, and thus any computation can be executed. Addition and subtraction can be performed without the servers communicating with one another, and multiplication can be performed by having each server transmit and receive m-bit data. When m=1, addition is an exclusive OR operation and multiplication is an AND operation, and arbitrary logical operations can be executed.

When the secure computation method described in Non-Patent Literature 1 is used, none of the input, the values during the course of computation, and the output of computation can be known from the data transmitted and received by a single server in the process of secure computation performed. However, this is only the case if all the servers follow the procedures of the secure computation method, but there is no way to determine whether or not each server is following the procedures.

Non-Patent Literature 2 discloses a secure computation method related to the 2-out-of-3 replicated secret sharing scheme by which it is possible to detect whether or not a server is following the procedures (hereinafter referred to as detection of an unauthorized action). In this method, unauthorized action detecting function is provided based on the secure computation method described in Non-Patent Literature 1, but the amount of communication related to multiplication is as large as 7-fold. Like in the case of Non-Patent Literature 1, no communication occurs regarding addition and subtraction. The probability of success of the unauthorized action detection in Non-Patent Literature 2 is 1½⁴⁰, and it does not depend on the value of m. 2⁴⁰ represents 40th power of 2.

Non-Patent Literatures 1 and 2 describe secure computation methods for addition, subtraction, and multiplication as well as logical operations. While it is possible to execute an arbitrary computation by these methods, they are not always efficient. As an example in which computation cannot be executed efficiently, processing of shuffling tabulated data, or the like may be raised.

Non-Patent Literature 3 discloses a secure computation processing by shuffling related to the 2-out-of-3 replicated secret sharing scheme. According to the protocol described in Non-Patent Literature 3, items in a table consisting of n pieces of m-bit data can be shuffled by performing three rounds of data transmission of 2n*m data. This amount of processing enables a much more efficient implementation of shuffle processing of the items in a table than in the case where shuffle processing of the items in a table is implemented by a logic circuit. Regarding this secure computation by shuffling, Non-Patent Literature 3 describes a method for distributing (s_1, s_2), (s_2, s_3), and (s_3, s_1) to three servers using s_1, s_2, and s_3 where the confidential information s satisfies s=(s_1+s_2+s_3) mod p using a prime number p greater than s. Here, m-th power of 2 may be used in place of p.

### CITATION LIST

### Non Patent Literature

Non-Patent Literature 1: Toshinori Araki, Jun Furukawa, Yehuda Lindell, Ariel Nof, Kazuma Ohara, “High-Throughput Semi-Honest Secure Three-Party Computation with an Honest Majority”
Non-Patent Literature 2: Toshinori Araki, Assi Barak, Jun Furukawa, Tamar Lichter, Yehuda Lindell, Ariel Nof, Kazuma Ohara, Adi Watzman, Or Weinstein, “Optimized Honest-Majority MPC for Malicious Adversaries—Breaking the 1 Billion-Gate Per Second Barrier” IEEE Symposium on Security and Privacy 2017, p. 843-862
Non-Patent Literature 3: Koki Hamada, Dai Ikarashi, Koji Senda, Katsumi Takahashi, “A Random Permutation Protocol on Three-Party Secure Function Evaluation”, CSS2010

### SUMMARY OF INVENTION

### Technical Problem

However, the unauthorized action detection method related to the shuffle secure computation disclosed in Non-Patent Literature 3 cannot be applied to the method described in Non-Patent Literature 1 since it utilizes the fact that p is a prime number. When p=2, the two methods are exactly the same, but the success rate of the unauthorized action detection by the method of detecting unauthorized actions is approximately 1-1/p, which means that the success rate of the unauthorized action detection cannot be raised.

An object of the present disclosure is to provide, in order to enable secure computation by shuffling that can detect an unauthorized action with high probability, a computation system and a computation method adapted to determine whether the distributed information in two tables are information about the same elements distributed as a set.

### Solution to Problem

A first example aspect of the present disclosure is a computation system including:

a table distributed information storage apparatus that stores distributed values in tables that are secretly distributed; and

a secure computation shuffling apparatus with unauthorized action detecting function, the apparatus comprising:
random-distributed bit generating means for generating distributed information of random values of K-bit security parameters in correspondence with distributed information of each row of the tables;
secure computation shuffling means for executing secure computation processing of shuffling by considering the distributed information of the random values corresponding to each row of the tables as a single row;
random bit sharing means for generating, as security parameters, K pieces of random data having a bit length equal to a length of each table; and
unauthorized action detecting means for determining, by secure computation for i=1, . . . , K, that an exclusive OR operation of values for all rows obtained by multiplying an exclusive OR operation of each row of the tables before the shuffling processing for each data designated by the i-th random data by the i-th random bit of each row is the same as an exclusive OR operation of values for all rows obtained by multiplying the exclusive OR operation of each row of the tables after the shuffling processing for each data designated by the i-th random data by the i-th random bit of each row.

A second example aspect of the present disclosure is a computation method including:

generating distributed information of random values of K-bit security parameters in correspondence with distributed information of each row of tables stored in a table distributed information storage apparatus;

executing secure computation processing of shuffling by considering the distributed information of the random values corresponding to each row of the tables as a single row;

generating, as security parameters, K pieces of random data having a bit length equal to a length of each table; and

determining, by secure computation for i=1, . . . , K, that an exclusive OR operation of values for all rows obtained by multiplying the exclusive OR operation of each row of the tables before the shuffling processing for each data designated by the i-th random data by the i-th random bit of each row is the same as an exclusive OR operation of values for all rows obtained by multiplying the exclusive OR operation of each row of the tables after the shuffling processing for each data designated by the i-th random data by the i-th random bit of each row.

### Advantageous Effects of Invention

According to the present disclosure, it is possible to provide, in order to enable secure computation by shuffling that can detect unauthorized actions with high probability, a computation system and a computation method adapted to determine whether the distributed information in two tables are information about the same elements distributed as a set.

### BRIEF DESCRIPTION OF DRAWINGS

FIG. 1A is a diagram showing data before shuffle processing according to a first example embodiment;

FIG. 1B is a diagram showing data after shuffle processing according to the first example embodiment;

FIG. 1C is a diagram showing data to be used in unauthorized action detection processing according to the first example embodiment;

FIG. 2 is a configuration diagram of a computation system according to the first example embodiment;

FIG. 3 is a diagram showing flow of processing executed in the computation system according to the first example embodiment;

FIG. 4 is a configuration diagram of a computation system according a second example embodiment;

FIG. 5 is a diagram showing flow of processing executed in the computation system according to the second example embodiment; and

FIG. 6 is a configuration diagram of a secure computation shuffling apparatus with unauthorized action detecting function or a secure computation sorting apparatus with unauthorized action detecting function.

### DESCRIPTION OF EMBODIMENTS

### First Example Embodiment

Notation relating to a secure computation method used in the present disclosure will be described. While there are many secure computation methods, the present disclosure will explain a secure computation method of a type in which input data is converted into a plurality of data and distributed across a plurality of servers by a technique called a secret sharing scheme. The plurality of data generated by the secret sharing scheme is called distributed information. An example of the secure computation method includes a method of recovering the original data by collecting the distributed information stored in every server. Further, as the secure computation method, there is a method in which the original data can be recovered when the distributed information stored in more than a certain number of servers is collected while keeping the original data private when the distributed information less than that for recovering the original data is collected.

The state in which data a is secretly distributed is represented by [a]. The secure computation by multiplication with respect to the distributed values a and b is represented by [a]*[b], the secure computation by addition is represented by [a]+[b], and the secure computation by subtraction is represented by [a]−[b].

It is possible to execute the secure computation even when either one of the data a and b is not distributed, and the secure computation that is executed in a state in which either one of the data a and b has not been distributed is represented by a*[b], a+[b], a−[b]. In such case, the result of the secure computation can be obtained in a state in which the data is distributed. For instance, when a*[b], the distributed information of [a*b] can be obtained.

Addition (including a+[b]), subtraction (including a−[b]) and constant multiple (including a*[b]) can be performed by each server. However, since multiplication ([a]*[b]) needs to perform communication among the servers, the amount of multiplication and the number of steps for the calculation largely affect the computation performance.

Hereinbelow, example embodiments of the present disclosure will be described with reference to the drawings. In the present disclosure when shuffling has been executed correctly, the tables before and after the shuffling match each other as a set. When the two tables match each other as a set, by rearranging the order of the rows in the table before the shuffle processing, it can be recreated into a table after the shuffle processing.

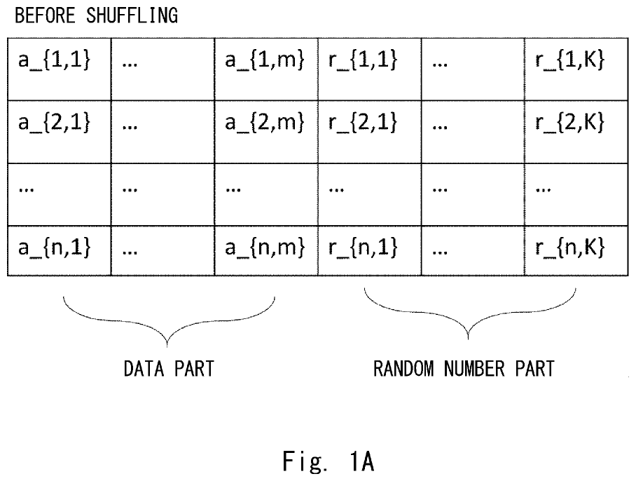

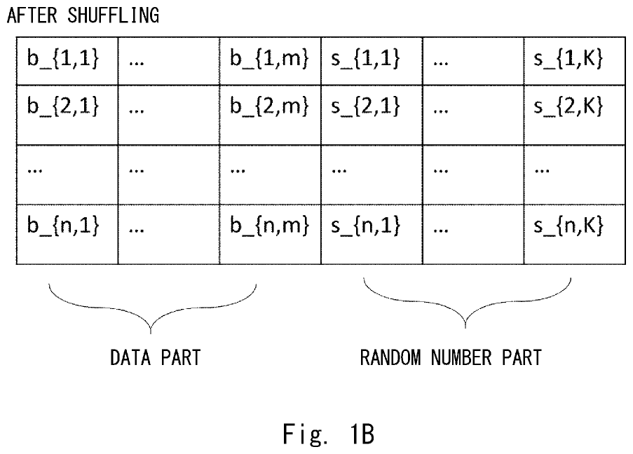

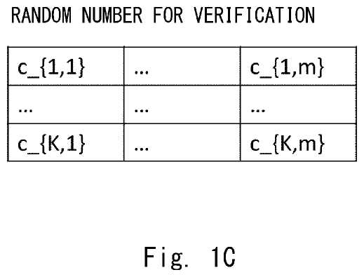

First, data before and after the shuffling processing will be described with reference to FIGS. 1A and 1B. First, let Table A be a table consisting of n pieces of data, each data being m-bit data. In Table A, the i-th piece of data is a_{i} and the i-th bit of a_{i} is a_{i,j}. Table A is shown in FIG. 1A. Each bit is distributed using the 2-out-of-3 replicated secret sharing scheme described in Non-Patent Literatures 1 and 2. Further, for each bit, secure computation related to bits can be carried out, unauthorized action detection processing can be applied, and secure computation by shuffling described in Non-Patent Literature 3 can be applied.

Next, using the distributed information of random bits of K-bit security parameters, K pieces of information is linked with each a_{i} with respect to the distributed information in each row of Table A. The value before the distribution of the j-th random bit r{i} to be linked with the i-th row of the table is r_{i,j}. The value before the distribution refers to a value that can be recovered when recovery processing is performed.

As a method of generating the distributed information of random bits, a method such as a pseudo-random number generating method described in Non-Patent Literature 1 can be used to effectively generate the distributed information, and any method that does not allow any server to know the distributed values may be employed.

Next, secure computation by shuffling is carried out on Table A by the method described in Non-Patent Literature 3. Table B is a table after shuffling is carried out, and the i-th piece of data in Table B is b_{i}, and the j-th bit of b_{i} is b_{i,j}. Table B is shown in FIG. 1B. To each b_{i} is linked K pieces of distributed information of random bit s{i}. The value before the distribution of the random bit of the j-th bit linked to b_{i} is s_{i.j}. It is to be noted that in shuffling, the secure computation method without the unauthorized action detecting function is used. Therefore, there is a possibility that the values of b_{i} and s_{i} may be different from the corresponding values in Table A due to unauthorized tampering of the server. All of these pieces of data are distributed in unit of bits and when these pieces of data are tampered with, it can be assumed that the data has been inverted.

Next, the servers cooperate with one another to generate K pairs of m-bit random number. The random number for the i-th pair is c_i, and the j-th bit of c_{i} is c_{i,j}. Each c_{i} is utilized in the unauthorized action detection processing. Each c_{i} utilized in the unauthorized action detection processing is shown in FIG. 1C. In the unauthorized action detection processing using c_{i}, c_{i,j} specifies that the j-th column of each of Tables A and B should be used. It is important that the value of c_i in K pairs is determined randomly by shuffling. The method of generating this random number may be any method insofar as the same random number can be shared among the servers. A basic method is having each server select a random bit and transmit it to the other servers and the exclusive OR of these random bits are set as the random number. The random number may be a distributed value, but for the sake efficiency, a recovered value is set as the random number.

Determination by the unauthorized action detection using c{k} can be performed by checking whether a_check_k=b_check_k holds in the following Expression when k=1, . . . , K.

$${a}_{check} = {\sum }_{i = 1}^{n} ( [ {r}_{i , k} ] ( {\sum }_{j = 1}^{m} {c}_{k , j} \cdot [ {a}_{i , j} ] ) ) mod 2 \qquad [ Expression 1 ]$$

$${b}_{check} = {\sum }_{i = 1}^{n} ( [ {s}_{i , k} ] ( {\sum }_{j = 1}^{m} {c}_{k , j} \cdot [ {b}_{i , j} ] ) ) mod 2 \qquad [ Expression 2 ]$$

c_{k,j} specifies that the j-th column in each table should be used in checking the k-th pair. r_{i,k} specifies that the i-th row in Table A should be used for a_check_k of the k-th pair. s{i,k} specifies that the i-th row in Table B should be used for b_check_k of the k-th pair.

The correspondence among the random numbers allocated to each of the rows does not change when the shuffle processing is carried out correctly and thus the aforementioned Expressions hold.

When, on the other hand, some of the bits has been inverted by tampering, it is difficult for all the Expressions to hold. This data inversion is caused due to distribution of r_{i,k} and s_{i,k} that specify use of the i-th row in the server by a method which even the servers are not aware of at the time of performing checking for the k-th time. Further, c_{k,j}, which specifies which j-th column is to be used, is determined after the shuffling whereby the check Expressions are satisfied, and this is a factor that makes it difficult for the Expressions to hold in the event of tampering.

For instance, a case where in the unauthorized action detection processing of r_{i,k} and s_{i,k}, c_{k,j} is not randomly selected, and all the values being 1 will be studied. In this case, when two items in a certain row are inverted, the result of the inverting is inverted again and the check Expressions hold. Furthermore, by inverting the whole table an even number of times, the check Expressions hold.

Inverting two items in the table when performing the unauthorized action detection processing of r_{i,k} and s_{i,k}, when c_{k,j} is set randomly will be studied. In this case, in order for the check Expressions to hold, the two items which have been inverted in the table need to satisfy either “neither items usable” or “both items usable” in all unauthorized action detections performed K times, which makes it difficult for the Expression to hold. “Both” refers to the two items in that have been inverted.

It should be noted that r_{i,k}, a_{i,j}, s_{i,k}, and b_{i,j} are in a distributed state. Each of a_check_k and b_check_k is computed by secure computation. Whether all of these match may be confirmed by recovering the values thereof. However, considering the possibility that these values divulge information about the columns of each row, only (a_check_1 XOR b_check_1 XOR 1) AND (a_check_2 XOR b_check_2 XOR 1) AND . . . AND (a_check_K XOR b_check_kK XOR 1) by which it is possible to confirm the equivalence of the information may be recovered.

Further in this process, by using the secure computation method disclosed in Patent Literature 2 by which unauthorized actions can be detected, it is possible to check any unauthorized action that has taken place in the process of computation. This is because the unauthorized action detection processing described above is configured of basic logical operations. Therefore, the unauthorized action that has taken place in the process of the checking described above can be detected separately, and so if the checking Expressions do not hold, it means that unauthorized action processing has taken place in the process of the shuffle processing.

In the above description, the data representing the tables can be secretly distributed for each bit, and any method may be used insofar as the method is a secure computation method having the unauthorized action detecting function related to the logical operations.

Further, explanation was given using the shuffling processing as an example, however it be applied to sorting processing. In this case, it is necessary to perform secure computation on the distributed information after the sorting processing for checking the large/small of the values of the information and to check whether the desired sorting (the ascending order, the descending order) has been performed. This processing needs to be performed by secure computation with the unauthorized action detecting function.

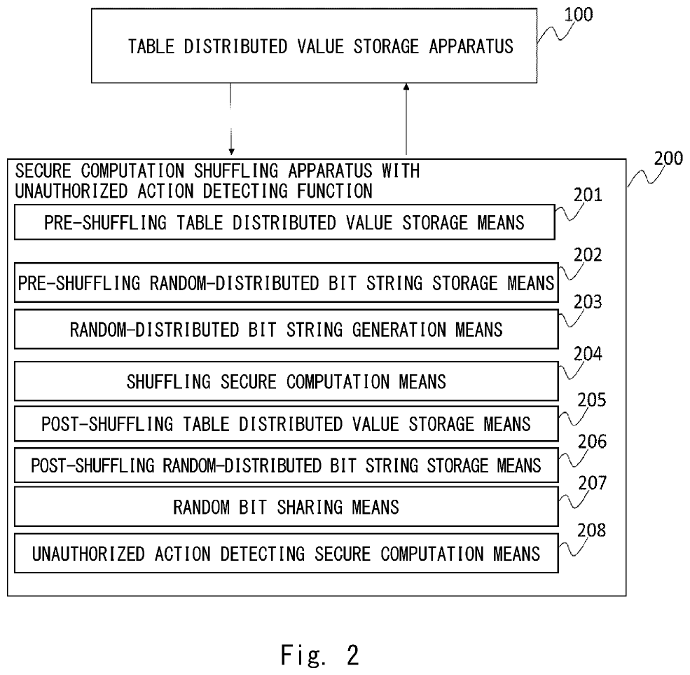

FIG. 2 is a block diagram showing a configuration according to the first example embodiment. The first example embodiment describes an example embodiment of performing shuffling processing by secure computation with authorized action detecting function using the protocol for determining the matching of the set.

Referring to FIG. 2, the computation system according to the first example embodiment of the present disclosure includes a table distributed value storage apparatus 100 and a secure computation shuffling apparatus with authorized action detecting function 200.

The table distributed value storage apparatus 100 stores the distributed values in the table before the shuffling and the distributed values in the table after the shuffling.

The secure computation shuffling apparatus with unauthorized action detecting function 200 includes a pre-shuffling table distributed value storage means 201, a pre-shuffling random-distributed bit string storage means 202, random-distributed bit string generating means 203, shuffling secure computation means 204, post-shuffling table distributed value storage means 205, post-shuffling random-distributed bit string storage means 206, random bit sharing means 207, and unauthorized action detecting secure computation means 208.

The secure computation shuffling apparatus with unauthorized action detecting function 200 reads out the distributed information in the table before the shuffling from the table distributed information storage apparatus 100 causes the table distributed information storage apparatus 100 to store the distributed information in the post-shuffling table. Note that the apparatus for storing the distributed information before shuffling and the apparatus for storing the distributed information after the shuffling may be the same apparatus or different apparatuses.

The pre-shuffling table distributed information storage means 201 reads out distributed information in the table on which shuffling is performed from the table distributed information storage apparatus 100. The number of rows in the table is n and the bit length of each record is m. The j-th bit of the data in the i-th row of the distributed information is [a_{i,j}].

The pre-shuffling random-distributed bit string storage means 202 stores the bit string of the distributed information.

The random-distributed bit string generating means 203 generates as many pieces of distributed information of a random bit string of K-bit security parameters as a number equal to the n-number of rows in the table stored in the pre-shuffling table distributed information storage apparatus 201, and stores the generated distributed information in the pre-shuffling random-distributed bit string storage means 202. The j-th bit of the i-th piece of data of the distributed information is [r_{i,j}].

The shuffling secure computation means 204 performs the secure computation by shuffling of the distributed information in the table in which the distributed information of the n-number of rows stored by the pre-shuffling table distributed information storage means 201 is linked with the n-pieces of distributed information stored by the random-distributed bit string storage means 202. Further, the shuffling secure computation means 204 causes the post-shuffling table distributed information storage means 205 to store, after the shuffling, the distributed information in the table as regards the result of the secure computation by shuffling and causes the post-shuffling random-distributed bit string storage means 206 to store the distributed information of a random-distributed bit string.

The j-th bit of the data in the i-th row of the distributed information stored in the post-shuffling table distributed information storage means 205 is [b_{i,j}].

The j-th bit of the i-th piece of data of the distributed information stored in the post-shuffling random-distributed bit string means 206 is [s_{i,j}].

The random bit sharing means 207 combines the random number of m-bits with K security parameters and shares the combination data among the servers for performing secure computation. The j-th bit of the random number of the i-th pair is c_{i,j}.

The unauthorized action detecting secure computation means 208 checks whether the following Expression (1) is satisfied as regards k=1, . . . K.

$$\begin{matrix}[ Expression 3 ] & \\ {\sum }_{i = 1}^{n} ( [ {r}_{i , k} ] ( {\sum }_{j = 1}^{m} {c}_{k , j} \cdot [ {a}_{i , j} ] ) ) = {\sum }_{i = 1}^{n} ( [ {s}_{i , k} ] ( {\sum }_{j = 1}^{m} {c}_{k , j} \cdot [ {b}_{i , j} ] ) ) mod 2 & ( 1 )\end{matrix}$$

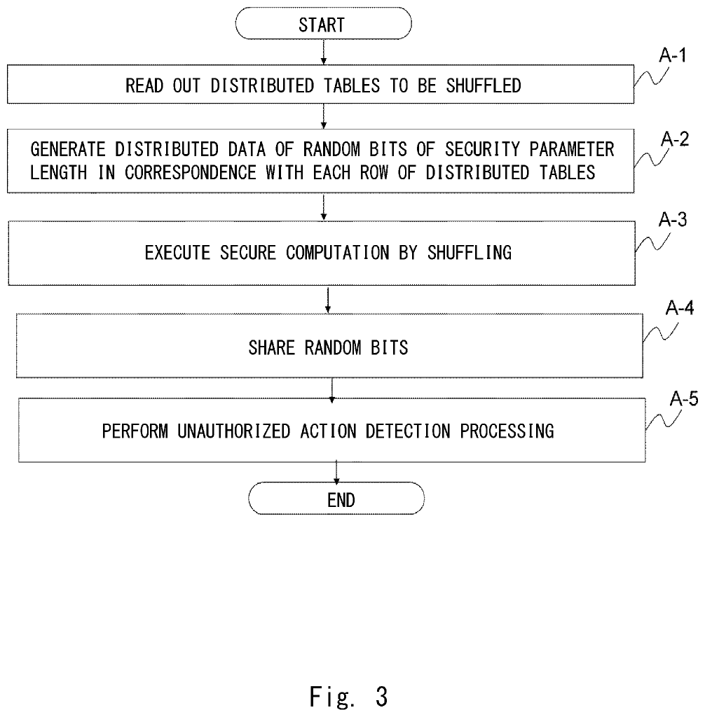

FIG. 3 is a flowchart showing an operation according to the first example embodiment of the present disclosure.

First, the secure computation shuffling apparatus with unauthorized action detecting function 200 reads out the distributed information in the pre-shuffling table from the table distributed information storage apparatus 100 and stores the read-out information in the pre-shuffling table distributed information storage means 201. The j-th bit of the data in the i-th row of the distributed information is [a_{i,j}] (Step A-1).

Next, the random-distributed bit string generating means 203 generates as many pieces of distributed information of a random bit string of K-bit security parameters as a number equal to the n-number of rows in the table stored in the pre-shuffling table distributed information storage apparatus 201. The random-distributed bit string generating means 203 stores the generated distributed information in the pre-shuffling random-distributed bit string storage means 202. The j-th bit of the i-th piece of data of the distributed information is [r_{i,j}] (Step A-2).

Next, the shuffling secure computation means 204 performs the secure computation processing by shuffling using a value in which the distributed information stored in the pre-shuffling table distributed information storage means 201 is linked with the distributed information stored in the pre-shuffling random-distributed bit string storage means 202. The shuffling secure computation means 204 causes the post-shuffling table distributed information storage means 205 to store, after the shuffling, the distributed information in the table as regards the result of the secure computation by shuffling and causes the post-shuffling random-distributed bit string storage means 206 to store the distributed information of the random-distributed bit string (Step A-3).

The j-th bit of the data in the i-th row of the distributed information stored by the post-shuffling table distributed value storage means 205 is [b_{i,j}]. The j-th bit of the i-th piece of data of the distributed information stored by the post-shuffling random-distributed bit string storage means 206 is [s_{i,j}].

Next, the random bit sharing means 207 combines the random number of m-bits with the K security parameters, the bit length of each element in the table being m, and shares the combination data among the servers for performing secure computation. The j-th bit of the random number of the i-th pair is c_{i,j} (Step A-4).

Next, the unauthorized action detecting secure computation means 208 checks whether Expression (1) is satisfied as regards k=1, . . . K (Step A-5).

### Second Example Embodiment

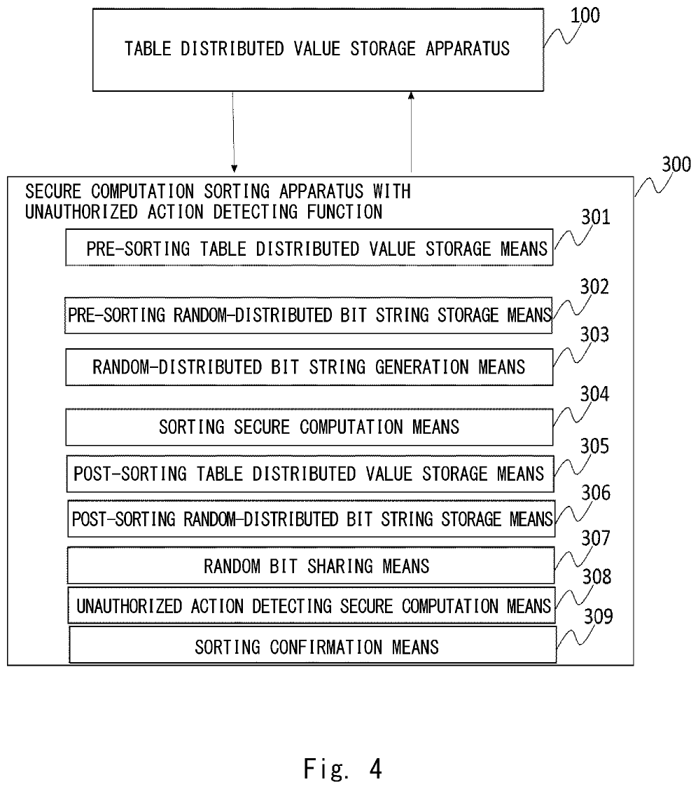

FIG. 4 is a block diagram of a computation system according to a second example embodiment. The second example embodiment is an example embodiment of performing sorting processing by secure computation with authorized action detecting function using the protocol for determining the matching of the set.

Referring to FIG. 4, the second example embodiment of the present disclosure is configured of the table distributed value storage apparatus 100 that stores the distributed information in the table and a secure computation sorting apparatus with unauthorized action detecting function 300.

The table distributed value storage apparatus 100 stores the distributed information in the table before the sorting and the distributed values in the table after the sorting.

The secure computation sorting apparatus with unauthorized action detecting function 300 includes pre-sorting table distributed value storage means 301, pre-sorting random-distributed bit string storage means 302, random-distributed bit string generating means 303, sorting secure computation means 304, post-sorting table distributed value storage means 305, post-sorting random-distributed bit string storage means 306, random bit sharing means 307, unauthorized action detecting secure computation means 308, and sorting confirmation means 309.

The secure computation sorting apparatus with unauthorized action detecting function 300 reads out distributed information in the table before the sorting from the table distributed information storage apparatus 100 and causes the table distributed information storage apparatus 100 to store the distributed information in the post-shuffling table.

Note that the apparatus for storing the distributed information before the sorting and the apparatus for storing the distributed information after the sorting may be the same apparatus or different apparatuses.

The pre-sorting table distributed information storage means 301 reads out distributed information in the table on which sorting is performed from the table distributed information storage apparatus 100. The number of rows in the table is n and the bit length of each record is m. The j-th bit of the data in the i-th row of the distributed information is [a_{i,j}].

The pre-sorting random-distributed bit string storage means 302 stores the bit string of the distributed information.

The random-distributed bit string generating means 303 generates as many pieces of distributed information of a random bit string of K-bit security parameters as a number equal to the n-number of rows in the table stored in the pre-sorting table distributed information storage apparatus 301, and stores the generated distributed information in the pre-sorting random-distributed bit string storage means 302. The j-th bit of the i-th piece of data of the distributed information is [r_{i,j}].

The shuffling secure computation means 304 performs the shuffle secure computation of the distributed information in the table in which the distributed information of the n-number of rows stored by the pre-shuffling table distributed information storage means 301 is linked with the n-pieces of distributed information stored by the random-distributed bit string storage means 302.

The sorting secure computation means 304 causes the post-shuffling table distributed information storage means 305 to store, after the shuffling, the distributed information in the table as regards the result of the sorting secure computation. Further, the sorting secure computation means 304 causes the post-sorting random-distributed bit string storage means 306 to store the distributed information of a random-distributed bit string.

The j-th bit of the data in the i-th row of the distributed information stored in the post-sorting table distributed information storage means 305 is [b_{i,j}].

The j-th bit of the i-th piece of data of the distributed information stored in the post-sorting random-distributed bit string storage means 306 is [s_{i,j}].

The random bit sharing means 307 combines the random number of m-bits with K security parameters and shares the combination data among the servers for performing secure computation. The j-th bit of the random number of the i-th pair is c{i,j}.

The unauthorized action detecting secure computation means 308 checks whether the Expression (1) is satisfied as regards k=1, . . . K.

The sorting confirmation means 309 confirms, by secure computation, whether the items in the table stored in the post-sorting table distributed information storage means 305 are sorted in the order to be satisfied.

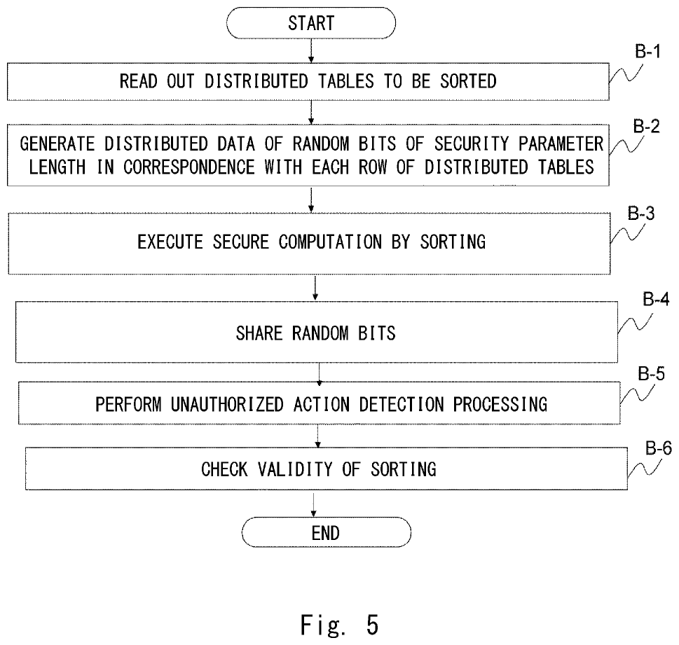

FIG. 5 is a flowchart showing an operation according to the second example embodiment of the present disclosure. The secure computation sorting apparatus with unauthorized action detecting function 300 reads out distributed information in the table before the sorting from the table distributed information storage apparatus 100 and causes the pre-sorting table distributed information storage means 301 to store the distributed information therein. The j-th bit of the data in the i-th row of the distributed information is [a_{i,j}] (Step B-1).

Next, the random-distributed bit string generating means 303 generates as many pieces of distributed information of a random bit string of K-bit security parameters as a number equal to the n-number of rows in the table stored in the pre-sorting table distributed information storage means 301. The random-distributed bit string generating means 303 stores the generated distributed information in the pre-sorting random-distributed bit string storage means 302. The j-th bit of the i-th piece of data of the distributed information is [r_{i,j}] (Step B-2).

Next, the sorting secure computation means 304 performs the sorting secure computation processing of a value in which the distributed information stored in the pre-sorting table distributed information storage means 301 is linked with the distributed information stored in the pre-sorting random-distributed bit string storage means 302. The sorting secure computation means 304 causes the post-sorting table distributed information storage means 305 to store the distributed information in the table as regards the result of the sorting secure computation and causes the post-sorting random-distributed bit string storage means 306 to store the distributed information of the random-distributed bit string (Step B-3).

The j-th bit of the data in the i-th row of the distributed information stored in the post-sorting table distributed value storage means 205 is [b_{i,j}]. The j-th bit of the i-th piece of data of the distributed information stored in the post-sorting random-distributed bit string storage means 206 is [s_{i,j}].

Next, the random bit sharing means 207 combines the random number of m-bits with the K security parameters, the bit length of each element in the table being m, and shares the combination data among the servers for performing secure computation. The j-th bit of the random number of the i-th pair is c_{i,j} (Step B-4).

Next, the unauthorized action detecting secure computation means 208 checks whether the Expression (1) is satisfied as regards k=1, . . . K (Step B-5).

Next, the sorting confirmation means 309 confirms, by secure computation, whether the order of the items in the table stored in the post-sorting table distributed information storage means 305 is in the order to be satisfied by the sorting (Step B-6).

### Third Example Embodiment

A third example embodiment is obtained by generalizing order-changing processing of the table in place of the sorting processing in the second example embodiment. In this case, processing of confirming the correctness of the order-changing processing of the table is performed in place of the sort-relationship confirmation apparatus 309. For instance, some of the rows in a table are dates, and it is assumed that sorting is performed on only these date parts in the table. This is effective so long as the correctness of the sort-relationship can be determined by logical expressions.

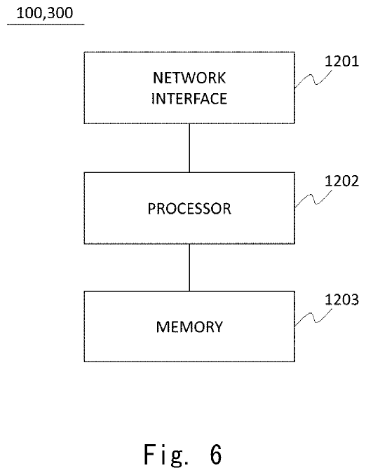

FIG. 6 is a block diagram showing an example of a configuration of the table distributed value storage apparatus 100 and a configuration of the secure computation sorting apparatus with unauthorized action detecting function 300 (hereinafter referred to as the table distributed value storage apparatus 100 etc.). Referring to FIG. 6, the table distributed value storage apparatus 100 etc. include a network interface 1201, a processor 1202, and a memory 1203. The network interface 1201 is used to establish communication with other network node apparatuses that the communication system is configured of. The network interface 1201 may include, for instance, a network interface card (NIC) in conformity with IEEE 802.3 series. Alternatively, the network interface 1201 may be used to perform wireless communication. For example, the network interface 1201 may be used to perform wireless LAN communication or mobile communication as defined in 3GPP (3rd Generation Partnership Project).

The processor 1202 performs the processing of the table distributed value storage apparatus 100 etc. described in the aforementioned example embodiments using flowcharts or sequences by reading out a software (a computer program) from the memory 1203 and implementing the program. The processor 1202 may be, for example, a microprocessor, MPU (Micro Processing Unit) or a CPU (Central Processing Unit). The processor 1202 may include a plurality of processors.

The memory 1203 may be configured by combing a volatile memory with a non-volatile memory. The memory 1203 may include a storage disposed so as to be distant from the processor 1202. In this case, the processor 1202 may access the memory 1203 via an illustrated I/O interface.

In the example shown in FIG. 6, the memory 1203 is used for storing a software module group. The processor 1202 can perform the processing of the table distributed value storage apparatus 100 etc. described in the aforementioned example embodiments by reading out a software module group from the memory 1203 and running the software modules.

As described with reference to FIG. 6, each processor of the table distributed value storage apparatus 100 etc. executes one or a plurality of programs including an instruction group for causing a computer to implement the algorithm described with reference to the drawings.

In the examples described above, the program can be stored and provided to a computer using any type of non-transitory computer readable media. Non-transitory computer readable media include any type of tangible storage media. Examples of non-transitory computer readable media include magnetic storage media, optical magnetic storage media (e.g. magneto-optical disks), CD-ROM (Read Only Memory), CD-R, CD-R/W, and semiconductor memories. Magnetic storage media may be, for example, floppy disks, magnetic tapes, hard disk drives, etc. Semiconductor memories may be, for example, mask ROM, PROM (Programmable ROM), EPROM (Erasable PROM), flash ROM, or RAM (Random Access Memory). The program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers, or a wireless communication line.

Note that the present disclosure is not limited to the above-described example embodiments, and can be appropriately changed without departing from the spirit of the present disclosure.

### REFERENCE SIGNS LIST

100 TABLE DISTRIBUTED VALUE STORAGE APPARATUS
200 SECURE COMPUTATION SHUFFLING APPARATUS WITH UNAUTHORIZED ACTION DETECTING FUNCTION
201 PRE-SHUFFLING TABLE DISTRIBUTED INFORMATION STORAGE MEANS
202 PRE-SHUFFLING RANDOM DISTRIBUTED BIT STRING STORAGE MEANS
203 RANDOM-DISTRIBUTED BIT STRING GENERATING MEANS
204 SHUFFLING SECURE COMPUTATION MEANS
205 POST-SHUFFLING TABLE DISTRIBUTED VALUE STORAGE MEANS
206 POST-SHUFFLING RANDOM DISTRIBUTED BIT STRING STORAGE MEANS
207 RANDOM BIT SHARING MEANS
208 UNAUTHORIZED ACTION DETECTION SECURE COMPUTATION MEANS
300 SECURE COMPUTATION SORTING APPARATUS WITH UNAUTHORIZED ACTION DETECTING FUNCTION
301 PRE-SORTING TABLE DISTRIBUTED VALUE STORAGE MEANS
302 PRE-SORTING RANDOM DISTRIBUTED BIT STRING STORAGE MEANS
303 RANDOM-DISTRIBUTED BIT STRING GENERATING MEANS
30 304 SORTING SECURE COMPUTATION MEANS
305 POST-SORTING TABLE DISTRIBUTED VALUE STORAGE MEANS
306 POST-SORTING RANDOM-DISTRIBUTED BIT STRING STORAGE MEANS
307 RANDOM BIT SHARING MEANS
308 UNAUTHORIZED ACTION DETECTION SECURE COMPUTATION MEANS
309 SORTING CONFIRMATION MEANS

1. A computation system comprising:
a table distributed information storage apparatus that stores distributed values in tables that are secretly distributed; and
a secure computation shuffling apparatus with authorized action detecting function, the apparatus comprising:
at least one memory storing instructions, and
at least one processor configured to execute the instructions to;
generate distributed information of random values of K-bit security parameters in correspondence with distributed information of each row of the tables;
execute secure computation processing of shuffling by considering the distributed information of the random values corresponding to each row of the tables as a single row;
generate, as security parameters, K pieces of random data having a bit length equal to a length of each table; and
determine, by secure computation for i=1, . . . , K, that an exclusive OR operation of values for all rows obtained by multiplying an exclusive OR operation of each row of the tables before the shuffling processing for each data designated by the i-th random data by the i-th random bit of each row is the same as an exclusive OR operation of values for all rows obtained by multiplying the exclusive OR operation of each row of the tables after the shuffling processing for each data designated by the i-th random data by the i-th random bit of each row.

2. A computation system comprising:
a table distributed information storage apparatus that stores distributed values in tables that are secretly distributed; and
a secure computation sorting apparatus with unauthorized action detecting function, the apparatus comprising:
at least one memory storing instructions, and
at least one processor configured to execute the instructions to;
generate distributed information of random values of K-bit security parameters in correspondence with distributed information of each row of the tables;
execute secure computation processing of sorting by considering the distributed information of the random values corresponding to each row of the tables as a single row;
generate, as security parameters, K pieces of random data having a bit length equal to a length of the tables;
determine, by secure computation for i=1, . . . , K, that an exclusive OR operation of values for all rows obtained by multiplying the exclusive OR operation of each row of the tables before the sorting processing for each data designated by the i-th random data by the i-th random bit of each row is the same as the exclusive OR operation of values for all rows obtained by multiplying the exclusive OR operation of each row of the tables after the sorting processing for each data designated by the i-th random data by the i-th random bit of each row; and
execute secure computation processing for determining whether the large/small relationship of values in the tables after the sorting processing among the tables is appropriate as the sorting processing.

3. A computation system comprising:
a table distributed information storage apparatus that stores distributed values in tables that are secretly distributed; and
a secure computation order changing apparatus with unauthorized action detecting function, the apparatus comprising:
at least one memory storing instructions, and
at least one processor configured to execute the instructions to;
generate distributed information of random values of K-bit security parameters in correspondence with distributed information of each row of the tables;
execute secure computation processing by order-changing regarding the distributed information of the random values corresponding to each row of the tables as a single row;
generate, as security parameters, K pieces of random data having a bit length equal to a length of the tables;
determine, by secure computation for i=1, . . . , K, that an exclusive OR operation of values for all rows obtained by multiplying the exclusive OR operation of each row of the tables before the order-changing processing for each data designated by the i-th random data by the i-th random bit of each row is the same as the exclusive OR operation of values for all rows obtained by multiplying the exclusive OR operation of each row in the table after the order-changing processing for each data designated by the i-th random data by the i-th random bit of each row; and
execute secure computation for determining whether the order of items in the tables after the order-changing processing meets the conditions for desired order-changing processing.

4. The computation system according to claim 1, wherein the at least one processor is further configured to execute the instructions to determine, by secure computation, whether the following Expression
$${\sum }_{i = 1}^{n} ( [ {r}_{i , k} ] ( {\sum }_{j = 1}^{m} {c}_{k , j} \cdot [ {a}_{i , j} ] ) ) = {\sum }_{i = 1}^{n} ( [ {s}_{i , k} ] ( {\sum }_{j = 1}^{m} {c}_{k , j} \cdot [ {b}_{i , j} ] ) ) mod 2 \qquad [ Expression 4 ]$$
is met for i=1, . . . , K when
the j-th bit of the data in the i-th row of the distributed information before the shuffling, the sorting, or the order-changing processing is [a_{i,j}], and the j-th bit of the random data corresponding to each row is [r_{i,j}],
the j-th bit of the data in the i-th row of the distributed information after the shuffling, the sorting, or the order-changing processing is [b_{i,j}], and the j-th bit of the random data corresponding to each row is [s_{i,j}], and
the j-th bit of the random data of the i-th pair shared by the random bit sharing means is c_{i,j}.

5. A computation method comprising:
generating distributed information of random values of K-bit security parameters in correspondence with distributed information of each row of tables stored in a table distributed information storage apparatus;
executing secure computation processing of shuffling by considering the distributed information of the random values corresponding to each row of the tables as a single row;
generating, as security parameters, K pieces of random data having a bit length equal to a length of each table; and
determining, by secure computation for i=1, . . . , K, that an exclusive OR operation of values for all rows obtained by multiplying the exclusive OR operation of each row of the tables before the shuffling processing for each data designated by the i-th random data by the i-th random bit of each row is the same as an exclusive OR operation of values for all rows obtained by multiplying the exclusive OR operation of each row of the tables after the shuffling processing for each data designated by the i-th random data by the i-th random bit of each row.

6. A computation method comprising:
generating distributed information of random values of K-bit security parameters in correspondence with distributed information of each row of tables stored in a table distributed information storage apparatus;
executing secure computation processing by shuffling regarding the distributed information of the random values corresponding to each row of the tables as a single row;
generating, as security parameters, K pieces of random data having a bit length equal to a length of the table;
determining, by secure computation for i=1, . . . , K, that an exclusive OR operation of values for all rows obtained by multiplying the exclusive OR operation of each row of the tables before the sorting processing for each data designated by the i-th random data by the i-th random bit of each row is the same as an exclusive OR operation of values for all rows obtained by multiplying the exclusive OR operation of each row of the tables after the sorting processing for each data designated by the i-th random data by the i-th random bit of each row; and
executing secure computation processing for determining whether the large/small relationship of values among the tables after the sorting processing is appropriate as the sorting processing.

7. A computation method comprising:
generating distributed information of random values of K-bit security parameters in correspondence with distributed information of each row of tables stored in a table distributed information storage apparatus;
executing secure computation processing by shuffling regarding the distributed information of the random values corresponding to each row of the tables as a single row;
generating, as security parameters, K pieces of random data having a bit length equal to a length of the table;
determining, by secure computation for i=1, . . . , K, that an exclusive OR operation of values for all rows obtained by multiplying the exclusive OR operation of each row of the tables before the order-changing processing for each data designated by the i-th random data by the i-th random bit of each row is the same as an exclusive OR operation of values for all rows obtained by multiplying the exclusive OR operation of each row of the tables after the order-changing processing for each data designated by the i-th random data by the i-th random bit of each row; and
executing secure computation processing for determining whether the large/small relationship of values among the tables after the order-changing processing is appropriate as the order-changing processing.

8. The computation system according to claim 2, wherein the at least one processor is further configured to execute the instructions to determine, by secure computation, whether the following Expression
$${\sum }_{i = 1}^{n} ( [ {r}_{i , k} ] ( {\sum }_{j = 1}^{m} {c}_{k , j} \cdot [ {a}_{i , j} ] ) ) = {\sum }_{i = 1}^{n} ( [ {s}_{i , k} ] ( {\sum }_{j = 1}^{m} {c}_{k , j} \cdot [ {b}_{i , j} ] ) ) mod 2 \qquad [ Expression 4 ]$$
is met for i=1, . . . , K when
the j-th bit of the data in the i-th row of the distributed information before the shuffling, the sorting, or the order-changing processing is [a_{i,j}], and the j-th bit of the random data corresponding to each row is [r_{i,j}],
the j-th bit of the data in the i-th row of the distributed information after the shuffling, the sorting, or the order-changing processing is [b_{i,j}], and the j-th bit of the random data corresponding to each row is [s_{i,j}], and
the j-th bit of the random data of the i-th pair shared by the random bit sharing means is c_{i,j}.

9. The computation system according to claim 3, wherein the at least one processor is further configured to execute the instructions to determine, by secure computation, whether the following Expression
$${\sum }_{i = 1}^{n} ( [ {r}_{i , k} ] ( {\sum }_{j = 1}^{m} {c}_{k , j} \cdot [ {a}_{i , j} ] ) ) = {\sum }_{i = 1}^{n} ( [ {s}_{i , k} ] ( {\sum }_{j = 1}^{m} {c}_{k , j} \cdot [ {b}_{i , j} ] ) ) mod 2 \qquad [ Expression 4 ]$$
is met for i=1, . . . , K when
the j-th bit of the data in the i-th row of the distributed information before the shuffling, the sorting, or the order-changing processing is [a_{i,j}], and the j-th bit of the random data corresponding to each row is [r_{i,j}],
the j-th bit of the data in the i-th row of the distributed information after the shuffling, the sorting, or the order-changing processing is [b_{i,j}], and the j-th bit of the random data corresponding to each row is [s_{i,j}], and
the j-th bit of the random data of the i-th pair shared by the random bit sharing means is c_{i,j}.
